(19) United States
(12) Patent Application Publication
(10) Pub. No.: US 2006/0182177 A1
(43) Pub. Date: Aug. 17, 2006

(54) System and method for video motion processing

(76) Inventors: Rod Thomson, Critchurch (NZ); Michael James Knee, Zee (GB); Martin Weston, Hampshire (GB)

Correspondence Address: PEARL COHEN ZEDEK, LLP, 1500 BROADWAY 12TH FLOOR, NEW YORK, NY, 10036, US

(21) Appl. No.: 10/527,425

(22) PCT Filed: Sep. 12, 2003
(86) PCT No.: PCT/GB03/03961

§ 371 Date: Oct. 25, 2005

(30) Foreign Application Priority Data
Sep. 12, 2002 (GB) 0221160.5

(51) Int. Cl. H04N 11/02; H04N 7/12; H04B 1/66; H04N 11/04

(52) U.S. Cl. 375/240.16

(57) ABSTRACT

In motion compensated video processing, a method of combining a plurality of pictures from an input sequence to form an output picture temporarily intermediate two of the input pictures by projecting input pixels to locations on the output picture according to motion vectors assigned to the input pixels, in which the mix of input pixels used to form an output pixel takes into account the number and nature of vectors which point to a given output pixel location from each input picture. In the case where there are a plurality of vectors from one input image pointing to the output pixel location the method may assign a lower weight to input pixels from that input picture, or may make a statistical analysis of the plurality of vectors in determining the output pixel. Alternatively increase weighting may be assigned to input pixels the respective vectors of which form conjugate pairs.

This invention is directed to picture building in motion compensated video processing.

Many contemporary standards conversion and other video processing systems employ motion compensation in order to Improve the quality of the output pictures. In such systems, it is a typical requirement for new output pictures to be interpolated from original input pictures. Motion compensation assigns motion vectors to the pixels of the input pictures, and these vectors are used to project the original pixels to “build” the output picture.

It is an object of the present invention to provide techniques for improving the quality of the output pictures of such systems.

Accordingly, the invention consists in one aspect in a method of motion compensated combination of two pictures of an input picture sequence to form an output picture at a temporal location between the two Input pictures, comprising: projecting input pixels from the input pictures to locations on the output picture using motion vectors assigned to those input pixels; counting the number of vectors from each input picture which point to a given pixel location on the output picture; and employing this count in controlling the mix of the pixels projected by those vectors used to produce the output pixel at the given pixel location.

The inventors have thus recognized that counting the number of vector “hits” at a particular output pixel location gives important information relating to the quality of the eventual output of the motion compensation process. Using this count to control the process therefore results in significant advances in quality.

Preferably, the method comprises employing a non-linear function of the count in controlling said mix.

In one form of the invention, the method comprises, where a plurality of vectors from one of the input pictures point to the given pixel location, assigning lower weight to the respective pixels of those vectors from that input picture for construction of the pixel at the given location. In another form, the method uses an average of the respective pixels of those vectors as the contribution to the output pixel from that input picture.

In still another form, the method comprises, where a plurality of vectors point to the given pixel location, taking a median of the vectors, and using the vector closest to the median for construction of the output pixel.

In another aspect, the invention provides a method of motion compensated combination of two pictures of an input picture sequence to form an output picture at a temporal location between the two input pictures, comprising: projecting input pixels from the input pictures to locations on the to output picture using motion vectors assigned to those input pixels; and mixing the respective pixels projected by the vectors onto the output picture to produce an output pixel at a given location, wherein, where a plurality of vectors from one of the input pictures project onto said given pixel location, giving increased weighting in controlling the mix to the respective pixels of vectors forming substantially conjugate pairs.

The invention will now be described by way of example with reference to the accompanying drawings, in which:

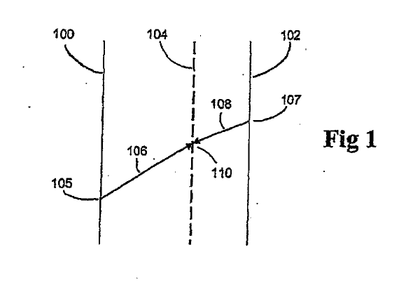

FIGS. 1 to 3 are diagrams illustrating the function of picture building in a typical motion compensated system; and

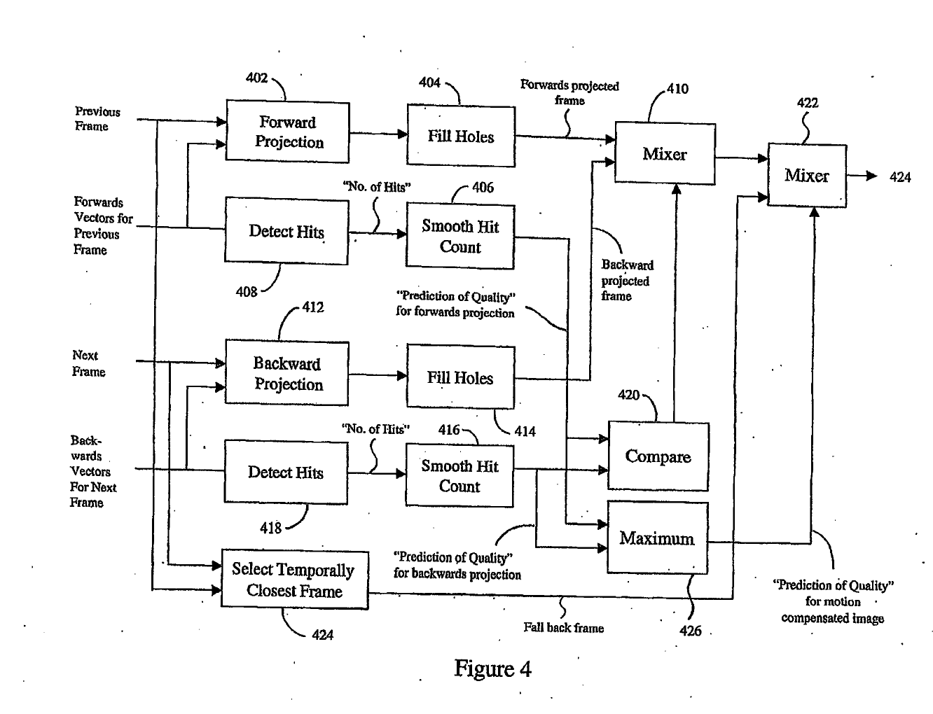

FIG. 4 is a diagram illustrating apparatus according to an embodiment of the invention.

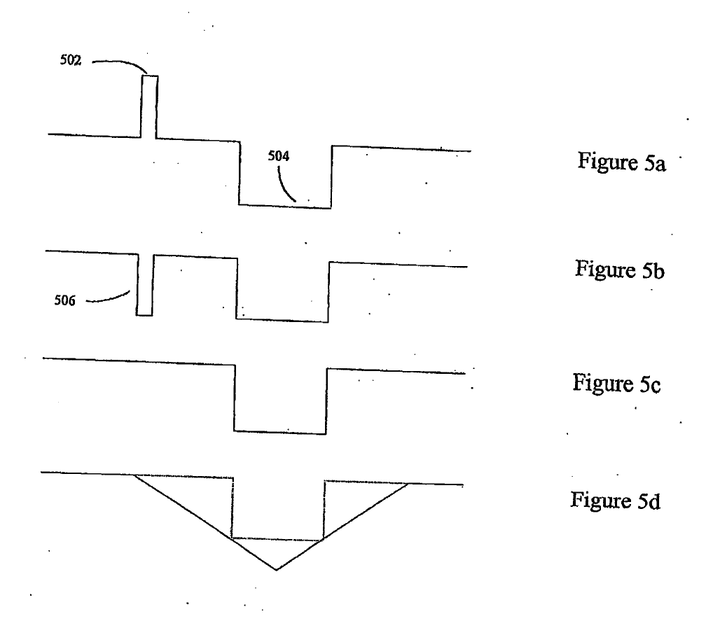

FIG. 5 illustrates an exemplary signal processing operation.

In motion compensated standards conversion, the process of picture building is typically important, the accuracy of the process greatly affecting the quality of the output images or pictures. The input pictures are typically in the form of video fields or frames, though of course, any type of input picture sequence may be employed in the embodiments described. Motion compensated picture building techniques are known to the art, and therefore the basic principles will not be discussed in detail here, though some description of the problems commonly arising follows.

In a picture building procedure, as illustrated in FIG. 1, two input pictures, in this case, two video frames (100 and 102) are used to create an output frame, indicated by dashed line 104. This output frame is to be created at a temporal position between the two input frames, though not necessarily equidistant from them.

In order to derive information illustrating the motion occurring between input images of an image sequence, a motion measurement process (of which the phase correlation technique is preferred) is performed on the input images. The resulting motion vectors are assigned to pixels or groups of pixels in the input image.

In the case illustrated in FIG. 1, vectors 106 and 108 have been assigned to objects in the two input frames; vector 106 points forward (temporally) towards the output frame position, from a pixel (105) on the first input frame (100), and vector 108 points backward from a pixel (107) in the second frame. The vectors are used to project the pixels (105, 107) from the input frames onto the pixel (110) of the output frame which is currently being constructed. A decision is then taken as to which of the pixels to use, or what proportion of each pixel to use in a mix of the two.

The above example, however, is merely a simple case where a single vector from each frame may be mapped to the required point. In other cases, there may not be a single vector, or there may be multiple vectors pointing to the output pixel position.

FIG. 2 illustrates one of these cases. Here, a vector (203) projects a pixel (202) from the following frame to the output pixel position (204), but there are two vectors, 201a and 201b, pointing from different pixels (200a, 200b) on the same, previous frame (100), to the same output pixel position (204). This may indicate, for example, that one object is moving over another In the current video sequence. It can be seen that similar situations will arise with multiple vector “hits” from either side of the output position, and with any number of hits (greater than one).

FIG. 3 illustrates a different situation. Here, a vector (301) projects a pixel (300) from the previous frame to the output pixel position (304), but there is no vector from the following frame.

In other cases there may not be a vector pointing to the output point from either side, in which case there is simply a hole in the output frame.

A prior method of picture building, as disclosed in EP 0,648,398, handles such situations in the following manner. If there is a single vector his from one frame at the output pixel, the resulting projection of the pixel from that frame is assigned a weighting value of 1. If there is a double hit, each vector is given a weighting of 1, giving an overall weighting for that frame or “side” (of the output position) of 2. Greater numbers of hits increase the total weighting thus. However, if there is no vector hit, the “confidence” in that fame is taken as zero; this therefore prevents the eventual mix of the output pixel taking any information from that frame or side which gave a zero hit result.

The inventors have recognized that a more sophisticated treatment of picture building which measures where multiple and zero hits occur can bring significant benefit over this prior technique in the quality of the output pictures.

In embodiments, the invention provides a system which identifies the occurrence of such “non-single hits” in the picture building process. The techniques described in the following apply the resulting counts to new methods of picture building which give the previously unexpected result of greatly increasing output picture quality.

In one embodiment, if there is any number of hits, from either of the input frames, which is not equal to one, the input from that frame is simply ignored. Thus in the case illustrated in FIG. 2, the input of both of the pixels 200a and 200b, projected by vectors 201a and 201b, would be ignored. The only information taken for the output pixel 204 would therefore be that provided by the following frame (102), from pixel 202 and vector 203. In the case illustrated in FIG. 3, the number of hits from the following frame is zero (which is not equal to 1), so that frame is ignored, and pixel 300 and vector 301 are used for the output pixel (304).

This method may also be implemented in a “softer” version. For example, where a multiple hit occurs, the system may nevertheless include some proportion, say 10%, of the offending vectors' source pixels in constructing the output pixel. This would be of particular use in cases where there are no hits on one side, and multiple hits on the other; at least some of the pixels from those vectors which would otherwise be ignored may be used for the output pixel.

In most cases, the system will employ some sort of “fallback” mode, in order to prevent failure, or allow a “hole” to appear in the output frame where there are no hits from either side.

FIG. 4 is a schematic diagram of a video processing apparatus according to one embodiment of the invention in which an output frame is constructed temporally intermediate two input frames. The previous frame and corresponding motion vectors are input to a forward projection stage 402. The resulting frame is then processed by hole filler 404, which fills small holes in the picture to produce a forwards projected frame which is input to a first input of mixer 410. The motion vectors for the previous frame are also input to a hit detector 408 which counts the number of motion vectors from the previous frame which point toward each pixel location in the forwards projected frame, to produce a “No. of hits” signal. This will tend to be a step or delta type function, and it is therefore passed to a processing stage 406 which produces, from the “No. of hits” a smoothly varying output, in order not to introduce sharp edging effects. This signal then acts as a “prediction of quality” for the forwards projected frame.

An example of a process performed by stages 406 and 416 will now be described briefly with reference to FIG. 5. A signal representing the number of hits is shown in FIG. 5a. Portion 502 registers 2 hits while extended portion 504 registers no hits. The rest of the signal represents a single hit. This signal is converted into the signal in FIG. 5b which represents those portions of the signal having a single hit as “high” and all other portions as “low”. In FIG. 5c the signal has been filtered to remove any very short variations such as that at 506. Finally, in FIG. 5d, any step edges are replaced by portions of constant slope providing a smoothly varying indication of quality, which provides a higher indication towards the edges of areas not having a single hit, moving to a lowest indication of quality at the center of such an area. In this example the slope is fitted to the signal in 5c such that the value of the ‘corners’ of the signal is maintained.

Returning now to FIG. 4, the next frame and corresponding motion vectors are processed, in a similar fashion to the previous frame, by elements 412, 414, 416 and 418 which are analogous to elements 402, 404, 406 and 408, to produce a backwards projected frame, and a “prediction of quality” for the backwards projected frame. The backwards projected frame is passed to the second input of mixer 410, while the two prediction of quality signals are input to comparison stage 420. Comparison stage 420 compares the prediction of quality signals for the two candidate frames input to mixer 410, and produces an output signal which controls the proportions of the candidate frames which are mixed, according to methods described previously.

The output from mixer 410 is passed to a first input of a further mixer 422. The second input to mixer 422 is a “fall back frame” which is provided by stage 424, which selects the input frame which is temporally closest to the output frame. Mixer 422 is controlled by controller 426 which, similar to comparison stage 420, receives the two prediction of quality signals for the respective forward and backward projected candidate frames. Controller 426 selects the greater of the two input signals which provides an overall prediction of quality for the output of mixer 410. This overall prediction of quality signal is used to control the proportions of input signals which are mixed at mixer 422 to produce the output 424.

Thus the previous frame is forward projected, and the following frame back projected to an intermediate temporal location, and the projections are mixed in dependence upon measurements of the number of hits arising on either side. Separate “predictions of quality”, dependent upon hit count, are derived for the previous and following frames, and these are compared to control the projection mix. For example, if a single hit is registered for a given pixel, the PoQ is high, whereas if a zero or multiple hit are registered, the PoQ is low.

In an alternative embodiment, the median of all vectors pointing to a given pixel on the output frame is taken. A number of options are then available: the closest vector to the median is taken, and the other vectors rejected; in a case where there is simply a double hit on one side, the offending vector is rejected as an outlier, as the other two vectors are closer to the median; fractions of the various vectors are taken, according to their proximity to the median. These approaches may be effective in cases where a plurality of spurious vectors produce the multiple hits.

In a further embodiment, the confidence assigned to the vector hits on one “side” of the output frame position is normalised. Thus if there is a double hit on one side, the contribution to the mix may be ¼ of each pixel in the double hit, and ½ of the pixel on the other side.

In a still further embodiment, where there are multiple hits, the vector on the “multiple hit side” are compared with those on the other side. If one vector is the conjugate (or near conjugate) of one of the vectors on the other side, as in FIG. 2, vectors 201b and 203, then the other vector, 201a, is discarded. Essentially, the only vectors taken for the decision on mixing the output pixel are such conjugate pairs, as these match the flow of the vector field along the current sequence.

In the embodiments described above, hit counts are generally described as integer values. In alternatives, if a phase correlation process is implemented to sub-pixel accuracy, then a more sophisticated approach is possible. The hit count becomes an accumulation over an area of non-integer hit values, rather than a simple count of vectors pointing to an integer value. Such “soft” hit counts may be processed as in any of the preceding methods in order to provide an output pixel.

In general, certain fallback options are required where zero hits or spurious vectors occur. For example, if vectors on either side produce an inequality or disagreement, the system may take the vector from the closest frame to the output temporal position. Where the hit count is zero on both sides, “holes” occur in the output frame. In such cases, “hole filling” or copying of pixels from either frame may be implemented. In other cases, the system may use the fallback picture, as in FIG. 4.

In the above description of certain embodiments of the invention, the example of the projection of two input pictures onto an output picture location is used. It should be noted that aspects of the invention are equally applicable to techniques in which more than two input pictures, and their respective pixels and assigned vectors, are used to create the output picture. Here, notwithstanding the methods described for weighting pixels in particular ways, the proportions of pixels used in the final mix may depend to a greater extent upon the distance of the input picture in question from the temporal location of the output picture.

It will be appreciated by those skilled in the art that the invention has been described by way of example only, and that a wide variety of alternative approaches may be adopted. In particular, the various methods described may be used in conjunction, in a variety of advantageous combinations.

1. A method of motion compensated combination of a plurality of pictures of an input picture sequence to form an output picture at a temporal location between two of the input pictures, the method comprising: projecting input pixels from the input pictures to locations on the output picture using motion vectors assigned to those input pixels; counting the number of vectors from each input picture which point to a given pixel location on the output picture; and employing this count in controlling the mix of the pixels projected by those vectors used to produce the output pixel at the given pixel location.

2. A method according to claim 1, comprising employing a non-linear function of the count in controlling said mix.

3. A method according to claim 1, comprising, where a plurality of vectors from one of the input pictures point to the given pixel location, assigning a lower weight to the respective pixels of those vectors from that input picture for construction of the pixel at the given location.

4. A method according to claim 1, comprising, where a plurality of vectors point to the given pixel location, taking a median of the vectors, and using the vector closest to the median for construction of the output pixel.

5. A method according to claim 1, comprising, where a plurality of vectors from one of the input pictures point to the given pixel location, using an average of the respective pixels of those vectors as the contribution to the output pixel from that input picture.

6. A method of motion compensated combination of a plurality of pictures of an input picture sequence to form an output picture at a temporal location between two of the input pictures, the method comprising: projecting input pixels from the input pictures to locations on the output picture using motion vectors assigned to those input pixels; and mixing the respective pixels projected by the vectors onto the output picture to produce an output pixel at a given location, wherein, where a plurality of vectors from one of the input pictures project onto said given pixel location, giving increased weighting in controlling the mix to the respective pixels of vectors forming substantially conjugate pairs.

7. Video processing apparatus for forming an output picture at a selected temporal location from a sequence of input pictures having associated motion vectors, the apparatus comprising:
a temporal picture projector for projecting input pictures to the temporal location of the output picture using the motion vectors associated respectively with said input pictures, to form projected pictures;
a counter for counting the number of motion vectors from the input pictures pointing towards each pixel of the respective projected picture for each of the input pictures; and
a first mixer for mixing the projected pictures, adapted to mix the pixels of projected pictures in varying proportions, such that at each pixel in the mix the relative proportion from each candidate picture is dependent on the number of motion vectors from the respective input picture pointing towards the spatial location of that pixel.

8. Apparatus according to claim 7, including a processor receiving from the counter, for each input picture, a signal representing the number of motion vectors pointing towards each pixel location, and processing this signal to produce, for each projected picture, a smoothed prediction of quality signal which is passed to the first mixer to control the mixing of candidate pictures.

9. Apparatus according to claim 8, further comprising a second mixer which receives as its inputs the output of the first mixer and a selected one of the input pictures, adapted to mix its inputs in varying proportions according to an overall prediction of quality signal derived from the prediction of quality signals for each candidate picture.

10. Apparatus according to claim 9, wherein the selected one of the input pictures is the picture temporally closest to the temporal location of the output picture.
